(19) United States
(12) Patent Application Publication
(10) Pub. No.: US 2008/0082855 A1
(43) Pub. Date: Apr. 3, 2008

(54) Data receiving device and receiving method thereof

(75) Inventors: Hideo Katou, Kawasaki (JP); Shinichirou Kobayashi, Kawasaki (JP); Yoshihisa Nakayama, Kawasaki (JP); Masayo Terada, Kawasaki (JP); Hiroaki Uno, Kawasaki (JP); Hideki Tanaka, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/706,699

(22) Filed: Feb. 15, 2007

(30) Foreign Application Priority Data
Sep. 28, 2006 (JP) JP2006-264154

(51) Int. Cl. G06F 1/04

(52) U.S. Cl. 713/502

(57) ABSTRACT

The present invention is a data receiving device for receiving data created with a plurality of bits for each frame, and acquiring this data based on a receive side clock, wherein a timing candidate generation section generates at least three clock timings within the bit cycle as candidates of a data acquisition timing, a header read monitoring section reads a data signal at each clock timing of the timing candidate and monitors if the header is correctly read at each clock timing, a timing decision section decides the timing candidate at the center as the data acquisition timing if there are three or more timing candidates at which the header was correctly read, and a data acquisition section acquires the receive data at the decided data acquisition timing.

### BACKGROUND OF THE INVENTION

The present invention relates to a data receiving device and a receiving method thereof, and more particularly to a data receiving device and a receiving method thereof for receiving data created with a plurality of bits per frame, and acquiring this data at the receive side clock.

As FIG. 27 shows, a transmission data creation section 1a at the transmission side 1 creates and sends data synchronizing the transmission side clock generated by a clock generator 1b, and a receive data acquisition section 2a at the receive side 2 acquires the receive data synchronizing the receive side clock generated by a clock generator 2b. In this case, both the clock generators 1b and 2b at the transmission side and the receive side generate clocks when enabled by the synchronization clock, but because of a delay in the transmission path and the individual performance of the clock generator, a frequency deviation, jitter and phase difference exists between these clocks. Therefore the receive side 2 must acquire the data signals, sent from the transmission side 1, as asynchronous data. To implement this, the following two technologies have been proposed.

The first method is that the transmission side sends clocks and data, the receive side stores the receive data in a buffer using the clocks of the transmission side, adjusts the phases of the transmission/receive clocks, acquires the receive data using clocks of the receive side, and switches to the clocks of the receive side from the clocks of the transmission side (JP 2000-183996A).

FIG. 28 is a block diagram of key sections of this data receiving device, and FIG. 29 is a time chart for describing operation, where one cycle of the transmission data (a) is the same as six cycles of the transmission clock (b) and receive clock (f).

A self-advancing counter section 3a counts the transmission clock (b), a decoding section 3b decodes the counter value of the self-advancing counter, and generates a acquisition timing signal (d) when the counter reaches a predetermined count value (self-advancing counter value=“C” in this example), and the transmission data acquisition section 3c acquires the transmission data using this acquisition timing signal. An acquisition timing generation section 3d counts the receive clock (f) after the value of the self-advancing counter becomes “C”, and generates the acquisition timing signal (g) when the counter becomes a predetermined count value (count value=“C”, in this example). This acquisition timing signal (g) is generated so as to be a timing at which the transmission data (e) acquired by the transmission data acquisition section 3c can be reacquired with certainty. A clock switching section 3e reacquires the transmission data (e) acquired by the transmission data acquisition section 3c at this acquisition timing (g), and implements the switching of clocks by outputting the reacquired transmission data (h).

The second method is that a transmission timing signal (b), which indicates the first position of the data, and the data (a) are sent from the transmission side, and the receive side judges the data acquisition timing based on the signal which indicates the first position of the data, so that data is always acquired at a stable position (JP04-078247A and JP3371844).

FIG. 30 is a block diagram of key sections of this data receive device, and FIG. 31 is a time chart for describing the operation, where one cycle of the transmission data (a) is the same as six cycles of the receive clock (c).

An edge detection section 4a detects an edge of the transmission timing (b) which indicates the first position of the data, then counts the receive clock (c), and generates an edge signal (d) when the counter reaches a predetermined count value, that is, when the timing at which transmission data can be acquired with certainty, and a timing generation section 4b generates a data acquisition timing signal (e) based on this edge signal, and a clock switching section 4c acquires the transmission data (a) at this acquisition timing (e), and outputs this acquired data (f) to implement the switching of clocks.

For the above mentioned data receiving device of prior art, the AC characteristics of clocks and input data must be considered, and if the data receiving device is mounted in an FPGA or LSI as a common circuit, the timing of the clock and transmission data or the timing of the transmission data and frame signal must be considered for each FPGA and LSI in designing.

If an already designed FPGA and LSI are used for another printed circuit board, the pattern in the printed circuit board must be redesigned.

The number of wirings on the printed circuit board must be decreased for higher packaging density, but in the case of the above mentioned prior art, data and clock, or data and transmission timing signal (frame signal) must be transmitted as a set, so two wirings are necessary, which makes wiring efficiency poor.

### SUMMARY OF THE INVENTION

With the foregoing in view, it is an object of the present invention to make it unnecessary to consider the AC characteristics for each FPGA or LSI, and make it unnecessary to consider AC characteristics when an already designed FPGA and LSI are mounted on another printed circuit board or back board.

It is another object of the present invention to make the number of wirings, from the transmission section to the receive section, to be one.

It is still another object of the present invention to decrease the read errors.

A first aspect of the present invention is a data receiving device for receiving data created with a plurality of bits in each frame, and acquiring the data based on a receive side clock, comprising: a data signal receive section for receiving a data signal which is the data created with a plurality of bits to which a header is attached at the beginning; a clock signal generation section for generating a clock signal of which cycles are shorter than the bit cycle; a timing candidate generation section for generating at least three clock timings within the bit cycle as candidates of a data acquisition timing; a header read monitoring section for reading the data signal at each clock timing of the timing candidates and monitoring if the header is correctly read at each clock timing; a timing decision section for deciding the timing candidate at the center as the data acquisition timing if there are three or more timing candidates at which the header has been correctly read; and a data acquisition section for acquiring the receive data at the decided data acquisition timing.

The timing decision section further comprises a counting section for counting the number of timing candidates at which the header has been correctly read, and a data acquisition timing decision section where when the number of the timing candidates is three and if there is one timing candidate at which the header has been read correctly, then this timing candidate is decided as the data acquisition timing, and if there are two timing candidates at which the header has been read correctly, the timing candidate generated first is decided as the data acquisition timing, and if there are three timing candidates at which the header has been read correctly, the second timing candidate is decided as the data acquisition timing.

The header read monitoring section comprises a shift register which is installed for each timing candidate, and is longer than the header length, for storing the result of reading a data signal at each timing candidate, and a monitoring section for monitoring whether the header is correctly read by comparing a latest data of the header length stored in the shift register with a known header.

In the above mentioned data receiving device, the header read monitoring section reads data for the header length from the n-th bit of the shift register if a shift amount according to the processing time from the detection of the header to the decision of the data acquisition timing is n bits, and inputs the data to the data acquisition section, and the data acquisition section acquires the data for the header length at the decided data acquisition timing bit by bit.

A second aspect of the present invention is a data receiving method for receiving data created with a plurality of bits in each frame, and acquiring the data based on a receive side clock, comprising the steps of: receiving a data signal which is the data created with a plurality of bits to which a header is attached at the beginning; generating a clock signal of which cycle is shorter than the bit cycle; generating at least three clock timings within the bit cycle as candidates of a data acquisition timing; reading the data signal at each clock timing of the timing candidates and monitoring if the header is correctly read at each clock timing; deciding the timing candidate at the center as the data acquisition timing if there are three or more timing candidates at which the header has been correctly read; and acquiring the receive data at the decided data acquisition timing.

According to the present invention, it is sufficient to send only the data signal from the transmission section to the receive section, and it is unnecessary to send the clocks and the transmission timing signal which indicates the first position of the data. Therefore the number of wirings can be decreased, and the AC characteristics of the clocks need not be considered, therefore FPGA/LSI design and printed circuit board design become easy.

Also according to the present invention, the header attached to the beginning of the data is detected and data can be acquired avoiding the boundary portion of the data, therefore read errors are decreased.

Also according to the present invention, it is unnecessary to consider AC characteristics when a designed FPGA and LSI are mounted on different printed circuit boards or back boards, so the FPGA and LSI can be commonly used directly.

Also according to the present invention, the header is detected and data is acquired avoiding the boundary portion of the data, so the data bit rate can be variable by changing the clock frequency, and the transmission data volume can be variable as a result.

Also according to the present invention, any frequency can be used without adjusting the AC characteristics if the frequency is less than the maximum operable frequency. Therefore the data receiving device of this invention can be mounted on a different printed circuit board without changing design based on AC characteristics, and can be integrated into another FPGA or LSI and used at a different transfer rate.

Conventionally in the wiring between the transmission section and receive section, clock and data signal must be wired to be equal length in the pattern of the printed circuit board, which makes the pattern design of the printed circuit board complicated, and takes time in the design process. According to the present invention, communication is possible using only the data signal, so it is unnecessary to wire clocks, which makes it unnecessary to consider equal-length wiring between the transmission section and receive section.

Also according to the present invention, equal-length wiring for data between printed circuit boards is unnecessary, so flexibility of wiring on a back board can be increased. The wiring length from the transmission section to the receive section differs depending on the insertion position of the back board of the printed circuit board, but according to the present invention, it is not necessary to consider AC characteristics for all the insertion positions in the design process, so designing becomes easier.

Other features and advantages of the present invention will be apparent from the following description taken in conjunction with the accompanying drawings.

### BRIEF DESCRIPTION OF THE DRAWINGS

FIG. 1 is a diagram depicting the first frame format of the data signal used for the present invention;

FIG. 2 is a diagram depicting the second frame format of the data signal used for the present invention;

FIG. 3 is a block diagram depicting the entire receiving device according to the present invention;

FIG. 4 is a block diagram depicting the timing candidate generation section;

FIG. 5 is a time chart of the time candidate generation section;

FIG. 6 are diagrams depicting the phase relationships of data and the timing candidate signals en(1), en(2) and en(3);

FIG. 7 is a diagram depicting phase 1 to phase 6 with respect to the data;

FIG. 8 is a table for describing a combination of three phases;

FIG. 9 is a diagram depicting the relationship of the data reading status and data acquisition timing according to combination 1;

FIG. 10 are diagrams depicting the relationship of the data reading status and data acquisition timing according to all combinations;

FIG. 11 is a block diagram depicting the header read monitoring section;

FIG. 12 is a time chart of the header read monitoring section;

FIG. 13 is a block diagram depicting the first half of the data acquisition timing decision section;

FIG. 14 is a logical table for describing the flip-flop operation;

FIG. 15 is a logical table for describing the count operation of the counter;

FIG. 16 is a logical table for describing the operation of the data acquisition timing signal generation section;

FIG. 17 is a time chart of the data acquisition timing decision section;

FIG. 18 is a block diagram depicting the latter half of the data acquisition timing decision section;

FIG. 19 is a logical table for describing the operation of the timing shift section;

FIG. 20 is a logical table for describing the operation of the latch timing signal generation section;

FIG. 21 is a time chart of the latter half of the data acquisition timing decision section;

FIG. 22 is a block diagram depicting the data acquisition section;

FIG. 23 is a logical table for describing the operation of the frame pulse generation section;

FIG. 24 is a time chart for describing the frame pulse FP generation operation;

FIG. 25 is a logical table for describing the operation of the frame counter for generating a signal to indicate a data position;

FIG. 26 is a logical table for describing receive data generation;

FIG. 27 is a block diagram depicting the data communication system;

FIG. 28 is a block diagram depicting the key sections of the first data receiving device of prior art;

FIG. 29 is a time chart for describing the operation;

FIG. 30 is a block diagram depicting the key sections of the second data receiving device of prior art; and

FIG. 31 is a time chart for describing the operation.

### DESCRIPTION OF THE PREFERRED EMBODIMENTS

### (A) Frame Format

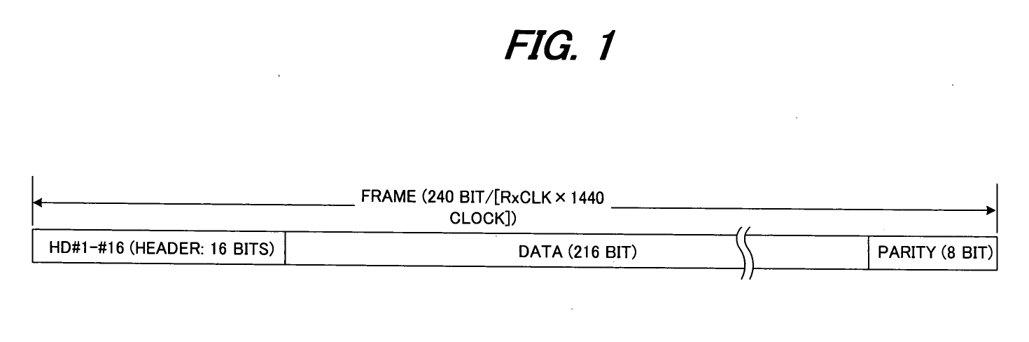

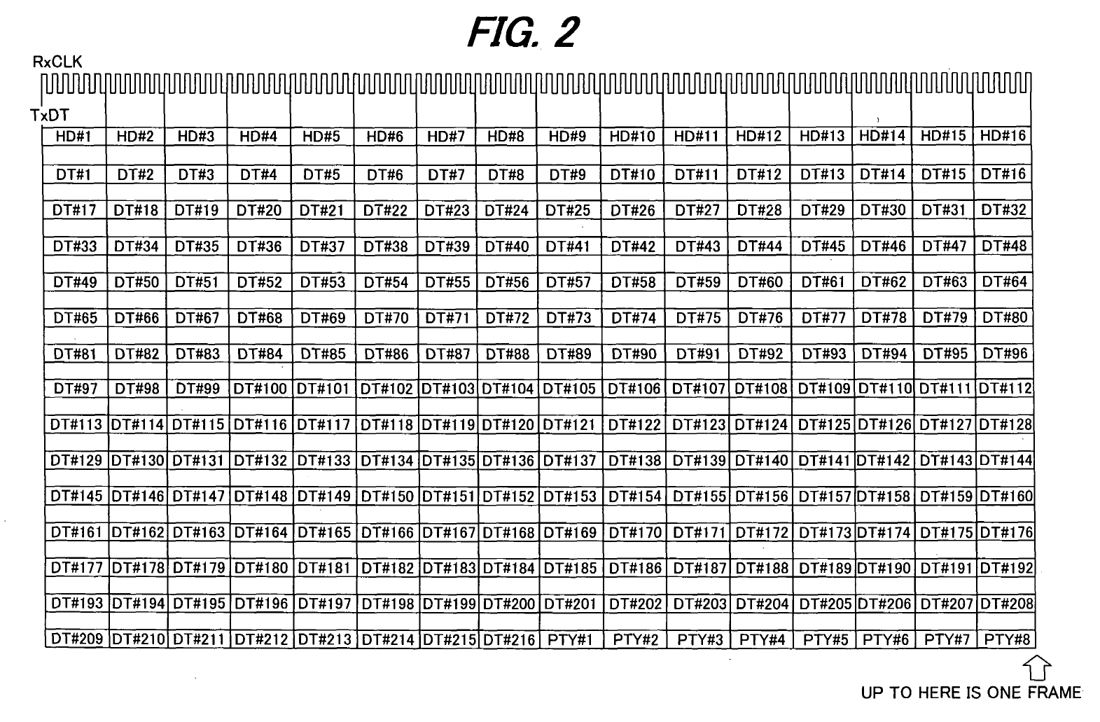

FIG. 1 and FIG. 2 are diagrams depicting the frame formats of data signals used for the present invention. A frame of the present invention consists of a header, 16 bits, data, 216 bits, and parity, 8 bits, totaling 240 bits. Each one bit consists of six receive clocks RxCLK, and data is sent at 1440 clocks per frame. The parity is computed and attached at every 27 bits. In other words, PTY#1 is a parity computing result of data DT#1 to DT#27, and PTY#2 is a parity computing result of DT#28 to DT#54, and so on.

### (B) General Configuration of Receiving Device

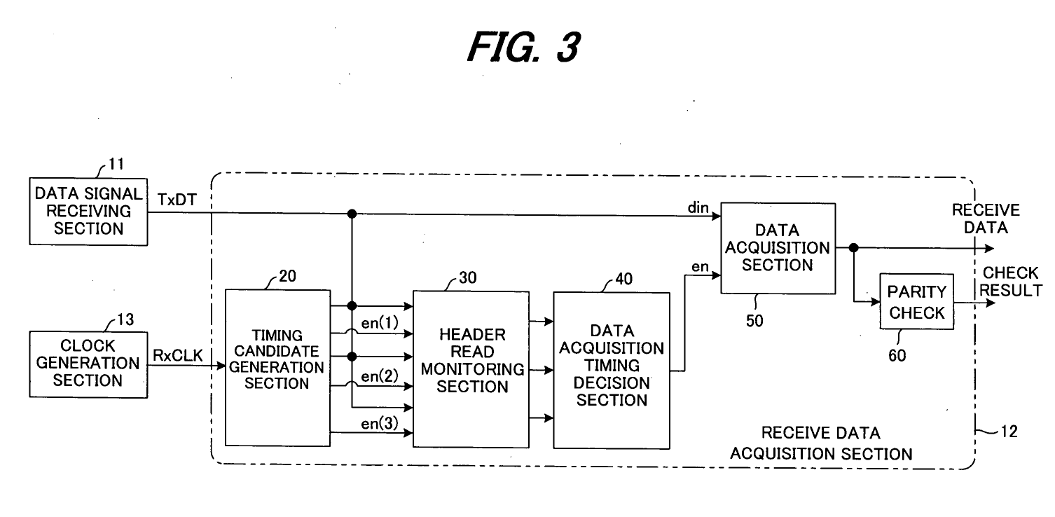

FIG. 3 is a block diagram depicting the entire receiving device of the present invention. A data signal receiving section 11 receives the data signal shown in FIG. 1 and FIG. 2, demodulates it, and inputs it to a receive data acquisition section 12, and a clock signal generation section 13 generates a clock signal RxCLK of which speed is six times that of a bit, and inputs it to the receive data acquisition section 12.

In the receive data acquisition section 12, the timing candidate generation section 20 generates three clock timings, that is, every other clock out of the six clocks in a bit cycle, as data acquisition timing candidates (phase en(1), en(2) and en(3)). A header read monitoring section 30 reads the data signal at each clock timing of the timing candidates, and monitors whether the header was correctly read at each clock timing. A data acquisition timing decision section 40 decides the clock timing, based on a predetermined timing candidate out of the timing candidates at which header was correctly read, as the data acquisition timing. For example, the data acquisition timing decision section 40 counts the number of timing candidates at which the header was correctly read, and when the number of timing candidates is three, and if there is one timing candidate at which the header was correctly read as 1, then this timing candidate is decided as the data acquisition timing, and if there are two such timing candidates, the timing candidate generated first is decided as the data acquisition timing, and if there are three such timing candidates, the second timing candidate is decided as the data acquisition timing.

A data acquisition section 50 acquires the receive data at the decided data acquisition timing, and a parity check section 60 performs parity check of the data acquired using the parity bit.

### (C) Timing Candidate Generation Section

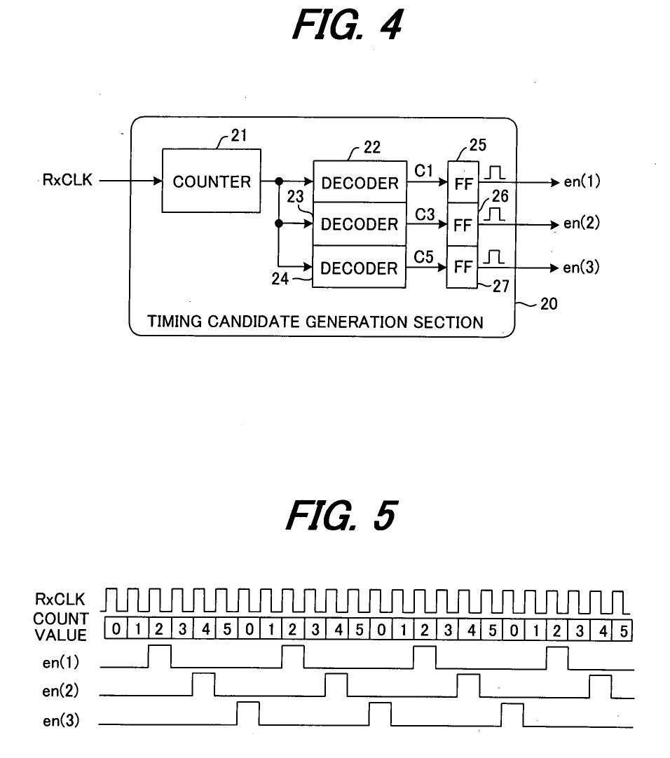

FIG. 4 is a block diagram depicting the timing candidate generation section 20, and FIG. 5 is a time chart of the timing candidate generation section in FIG. 4. The timing candidate generation section 20 includes a counter 21 based on a base 6 number system (count values are 0 to 5) for counting the clock signal RxCLK, decoders 22, 23 and 24 for generating high level signals C1, C3 and C5 when the count value is 1, 3 and 5, and flip-flops 25, 26 and 27 for generating timing candidate signals en(1), en(2) and en(3) with a one clock width respectively when the signals C1, C3 and C5 are at high level and a clock signal is generated.

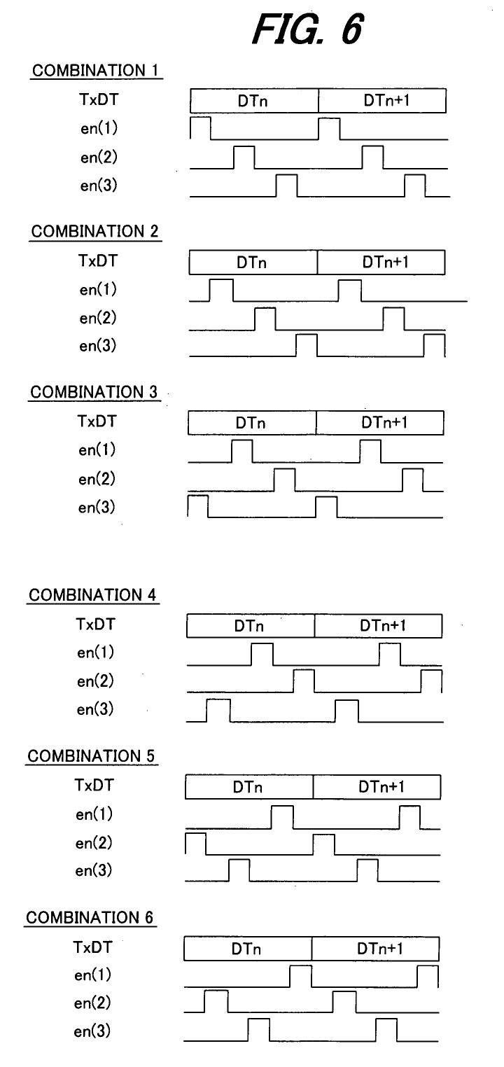

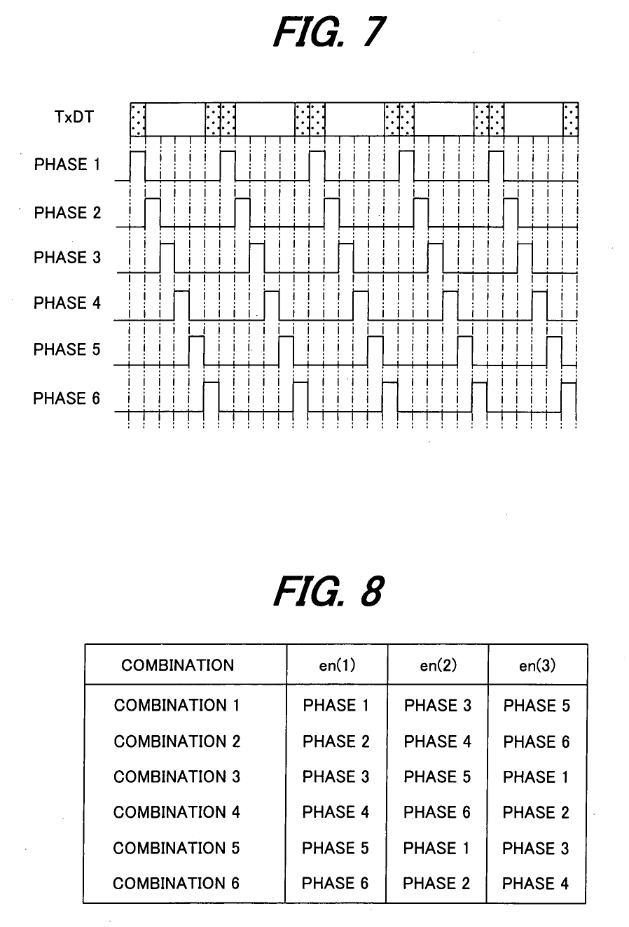

The phase relationship of the data and the timing candidate signals en(1), en(2) and en(3) depend on which phase timing (phase) when the counter 21 starts to count the clock signal RxCLK, and the six types of combinations shown in FIG. 6 are possible. Since the data cycle is six times the cycle of the clock signal RxCLK, the data cycle TxDT has six phases, and if each phase is expressed as phase 1 to phase 6, as shown in FIG. 7, the combination 1 to the combination 6 in FIG. 6 are regarded as a combination of the timing candidate signals each of which has a phase shown in FIG. 8.

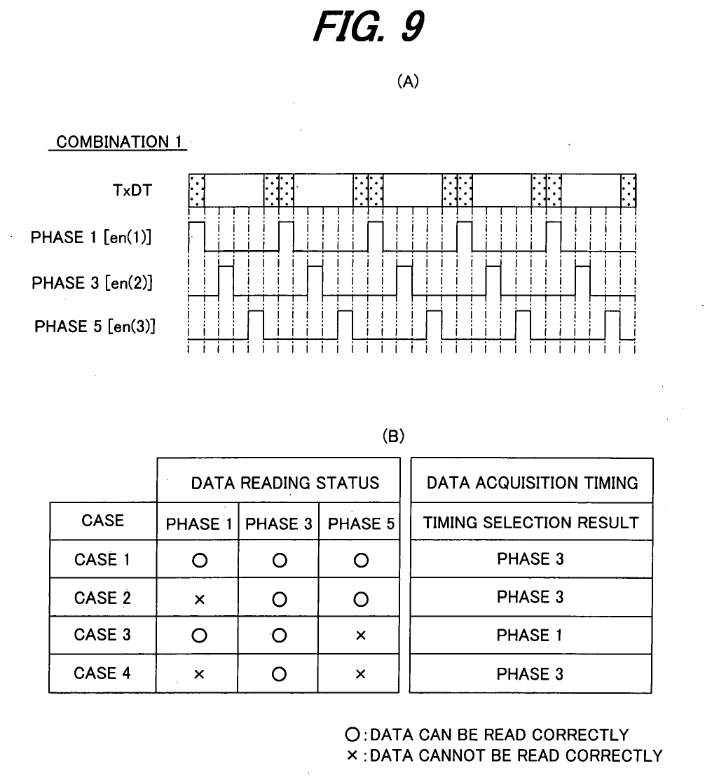

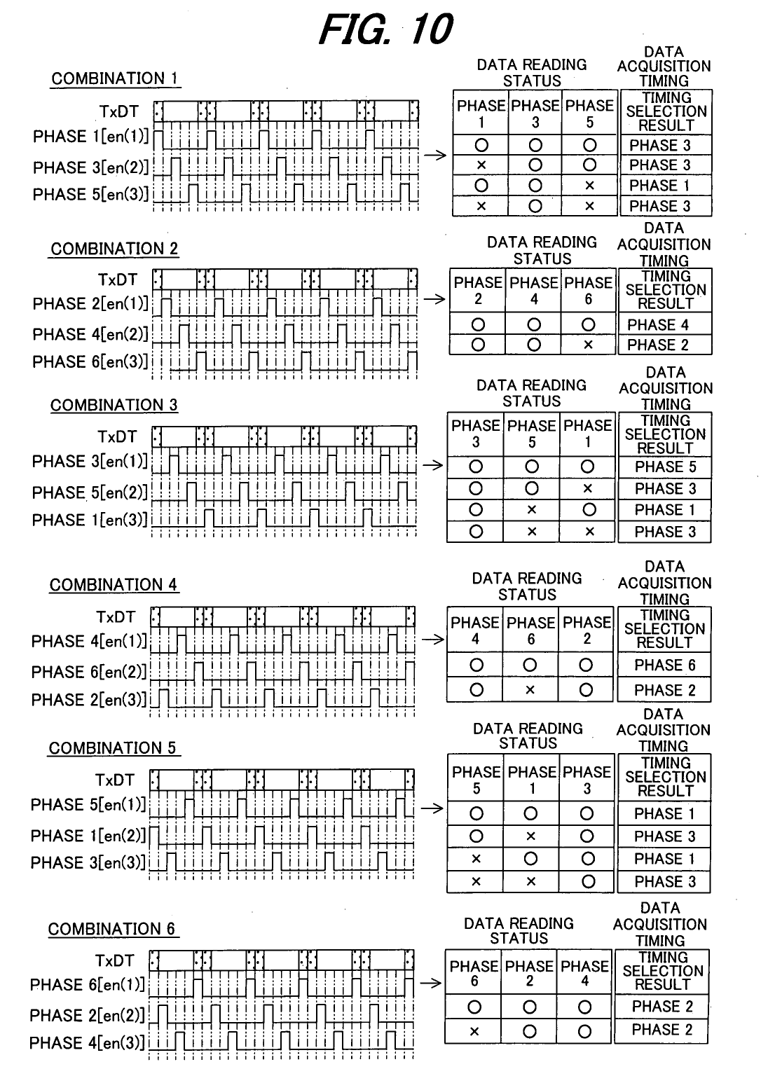

Out of the three timing candidate signals en(1), en(2) and en(3), a timing candidate signal which is close to the center of the data is the optimum as the data acquisition timing. Because for the data to be transmitted, it is highly possible that a data read error occurs at the boundary portion of the data (black dotted portion) in FIG. 7 due to the jitter component in the clock and the dispersion of delays on the printed circuit board, and data cannot be acquired correctly. In the case of the combination 1 in (A) of FIG. 9, if data can be correctly read at the three timing candidates en(1), en(2) and en(3) (phase 1, phase 3 and phase 5), as shown in case 1 in (B) of FIG. 9, the timing candidate at the center (phase 3) is decided as the data acquisition timing. If data can be correctly read at two timing candidates, as shown in cases 2 to 3 in (B) of FIG. 9, the timing candidate which is generated first (phase 3 or phase 1) is decided as the data acquisition timing, and if data can be correctly read only at one timing candidate, as shown in case 4 in (B) of FIG. 9, this timing candidate (phase 3) is decided as the data acquisition timing. In FIG. 9, combination 1 was described, but the same is true for the other combinations, and the data acquisition timing is decided as shown in FIG. 10.

### (D) Header Read Monitoring Section

FIG. 11 is a block diagram depicting the header read monitoring section 30, where 18-bit shift registers 31 to 33 shift and store the data TxDT read at the three timing candidate signals en(1), en(2) and en(3), input the 1st to 16th bit to the header detection sections 34 to 36, and output the 3rd to 18th bit as SFT (1), SFT (2) and SFT (3) respectively. The header detection sections 34 to 36 detect whether the header was correctly read by comparing the latest data (1^{st} to 16^{th} bit) of the header length (=16 bits) stored in the shift registers 31 to 33 and a known header (=5A3C(h): (h) means hexadecimal), and output the head detection signal HEAD_DET(1) to HEAD_DET(3) if the header was correctly read, respectively.

It requires period of about 2 bits from the detection of the header to the decision of the data acquisition timing, so finally the data acquisition section 50 acquires the data using one of the 3^{rd} to 18^{th} bit signals SFT (1), SFT (2) and SFT (3) after delaying 2 bits.

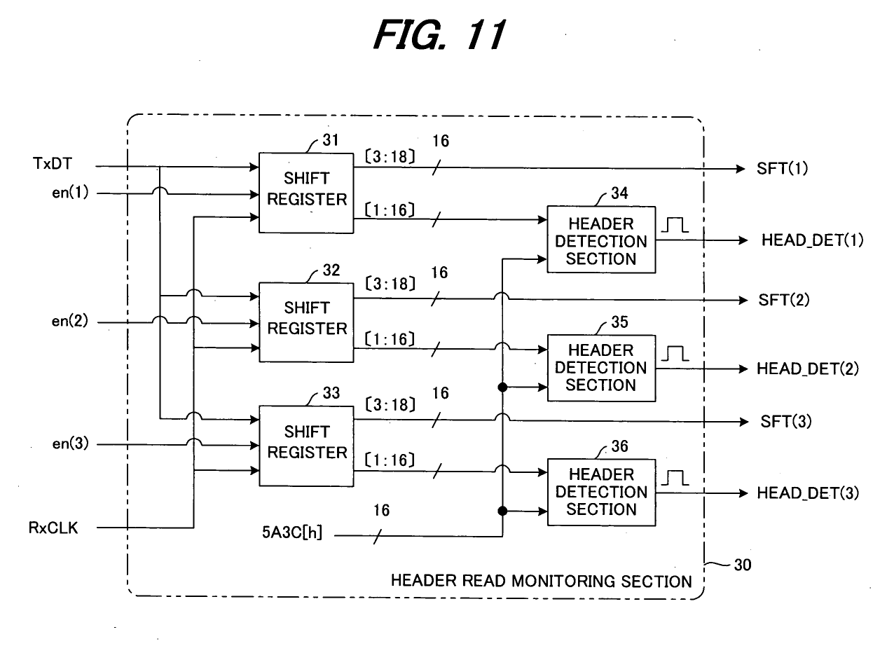

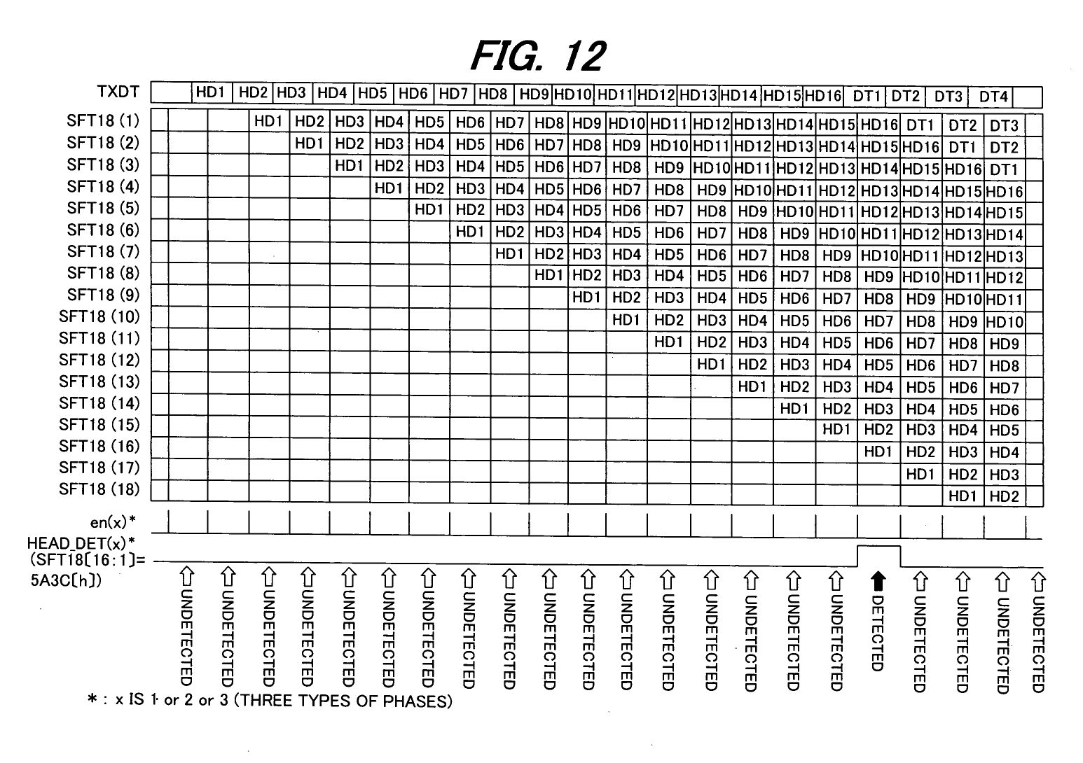

FIG. 12 is a time chart of the header read monitoring section 30, where SFT18(1) to SFT18(18) indicate the 18-bit content of the shift register, and the values are sequentially shifted in the right direction. When the headers HD16 to HD1 are stored in the 1^{st} to 16^{th} bit of the corresponding shift register, the header detection sections 34 to 36 output the header detection signals HEAD_DET(1) to HEAD_DET(3) if the content thereof SFT18 (1) to SFT18 (16) are the same as the known header, and output the content SFT18(3) to SFT18(18) of the 3^{rd} to 18^{th} bit after delaying 2 bits as SFT (1) to SFT (3).

### (E) Data Acquisition Timing Decision Section

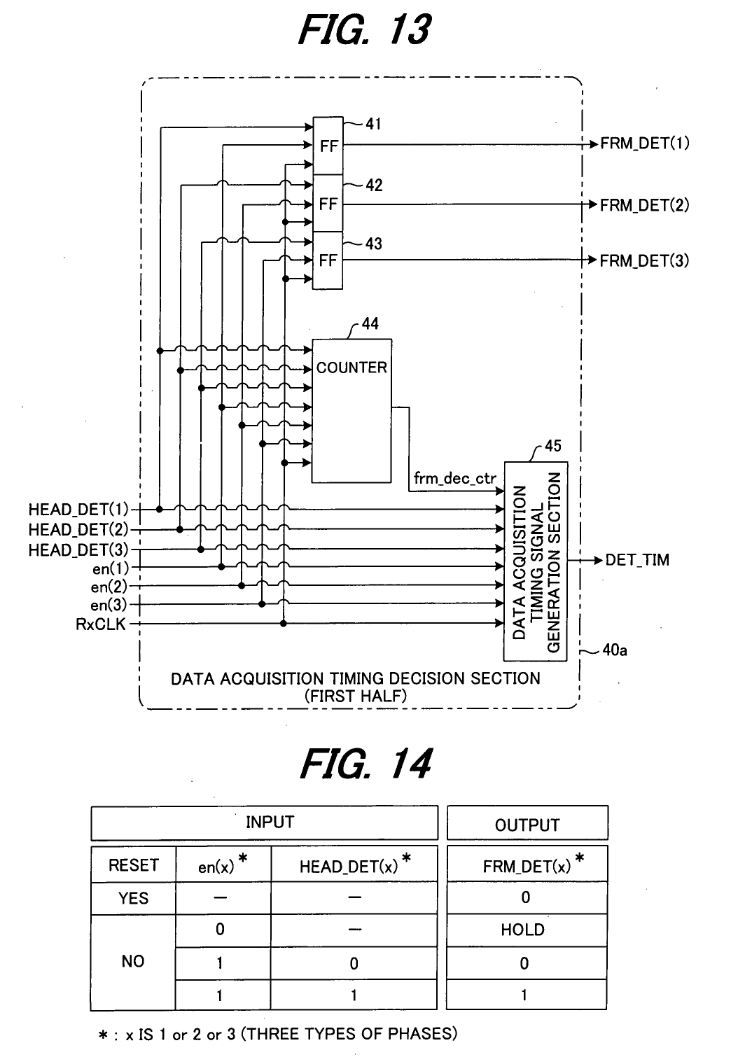

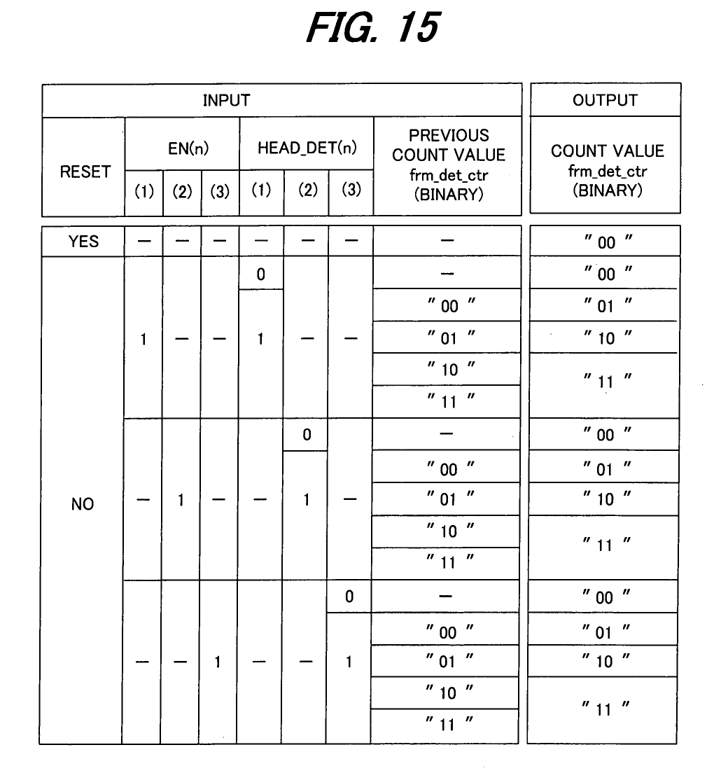

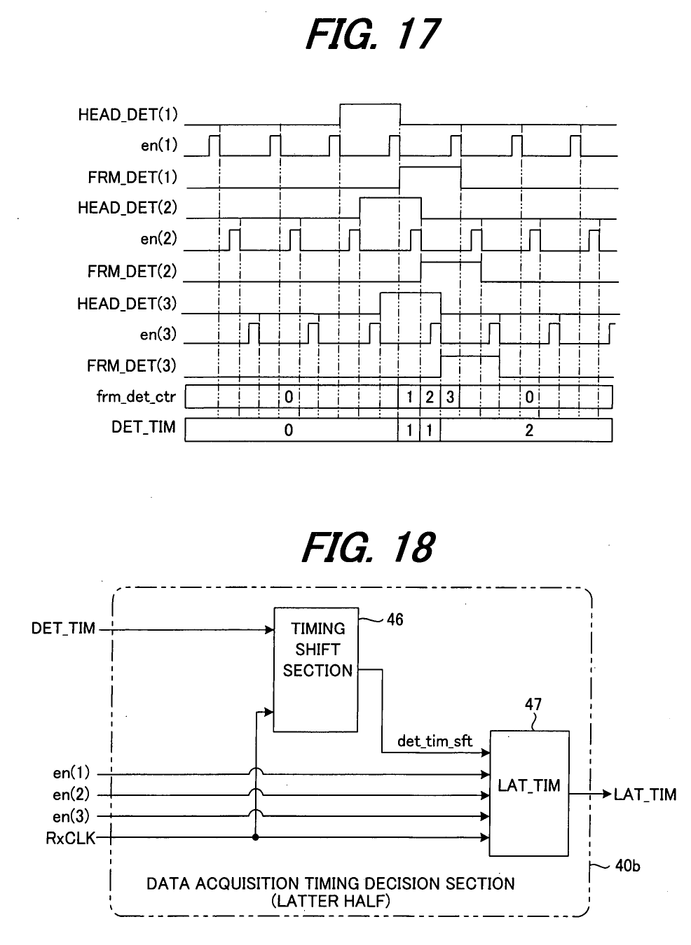

FIG. 13 is a block diagram depicting the first half 40a of the data acquisition timing decision section 40. The flip-flops 41 to 43 store the header detection signals HEAD_DET(1) to HEAD_DET(3), which are output from the header read monitoring section 30, using the timing candidate signals en(1), en(2) and en(3) according to the logical table shown in FIG. 14, and output the frame detection signals FRM_DET(1) to FRM_DET(3) which indicate the beginning of the data respectively, as the time chart in FIG. 17 shows. The counter 44 counts the header detection signals HEAD_DET(1) to HEAD_DET(3) synchronizing the timing candidate signals en(1), en(2) and en(3) according to the logical table shown in FIG. 15, and output the count value frm_det_ctr. For example, if HEAD_DET(x) is “0” when en(x) (x=1, 2, 3) is generated, the count value frm_det_ctr is cleared to 0, and if HEAD_DET(x) is “1” when en(x) is generated, the count value frm_det_ctr is incremented 1. The maximum value of the count value is 3 (=11). Therefore when HEAD_DET(1), HEAD_DET(2) and HEAD_DET(3) become 1 in this sequence, the count value frm_det_ctr becomes 0 [symbol] 1 [symbol] 2 [symbol] 3 [symbol] 0 as the time chart in FIG. 17 shows.

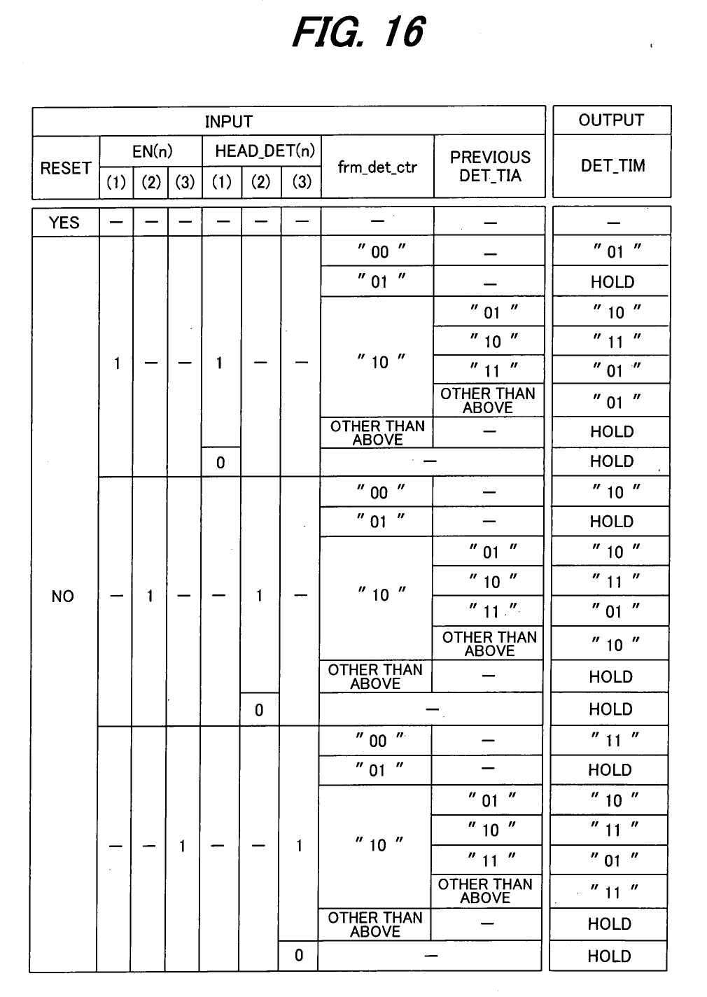

The data acquisition timing signal generation section 45 generates the data acquisition timing signal DET_TIM according to the logical table shown in FIG. 16, using the timing candidate signal en(x), header detection signal HEAD_DET(x), count value frm_det_ctr and previous DET_TIM. The data acquisition timing signal DET_TIM is binary, and 01 indicates that the data reading timing is en(1), 10 indicates that the data reading timing is en(2), and 11 indicates that the data reading timing is en(3).

In the data acquisition timing signal generation section 45, (1) if the header is correctly read at one of the three timing candidates en(1), en(2) and en(3), this timing candidate is decided as the data acquisition timing, and the signal DET_TIM is output, (2) if the header was correctly read at two timing candidates, the timing candidate which is generated first is decided as the data acquisition timing, and signal DET_TIM is output, and (3) if the header was correctly read at three timing candidates, the second timing candidate is decided as the data acquisition timing, and signal DET_TIM is output. For example, if the header was correctly read at three timing candidates, the data acquisition timing signal generation section 45 outputs 0 [symbol] 1 [symbol] 1 [symbol] 2 sequentially as DET_TIM as the time chart in FIG. 17 shows, and finally outputs the second timing candidate as the data acquisition timing DET_TIM.

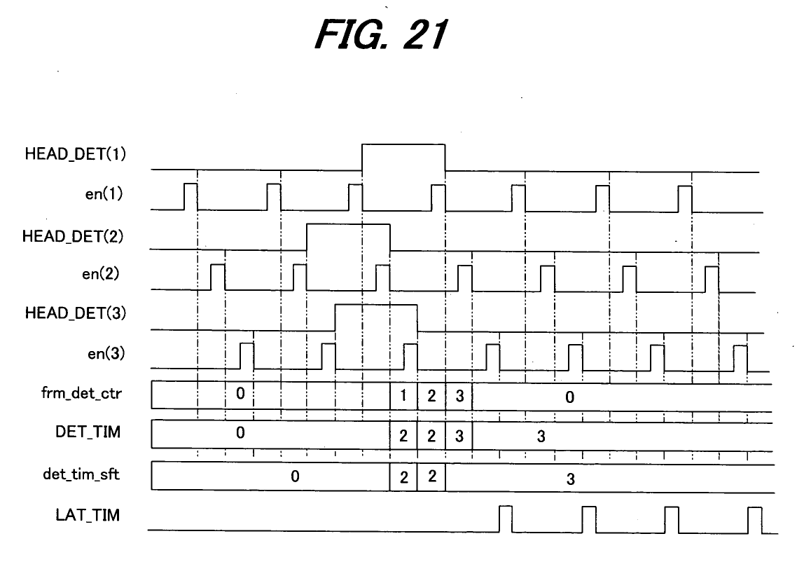

FIG. 18 is a block diagram depicting the latter half 40b of the data acquisition timing decision section 40, and FIG. 21 is the operation timing chart thereof.

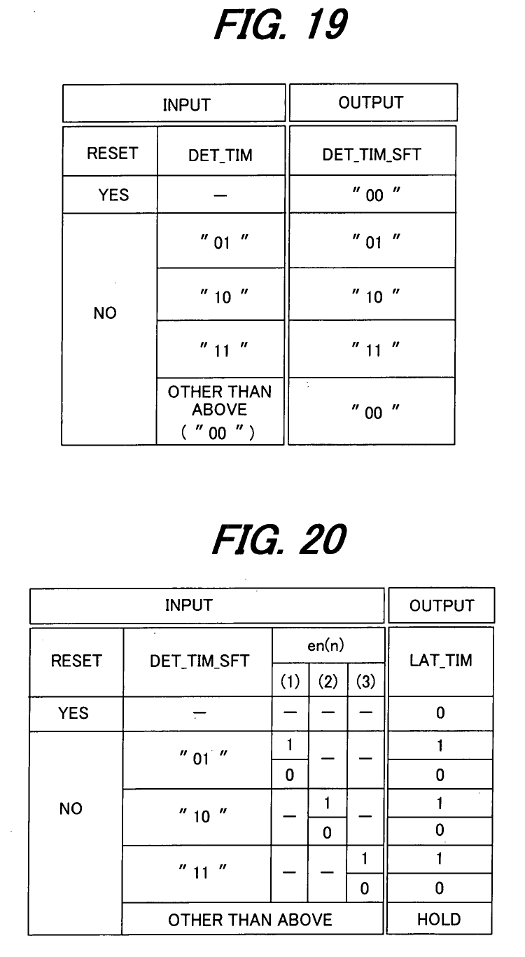

The timing shift section 46 shifts the data acquisition timing signal DET_TIM by 1 clock based on the receive clock according to the logical table shown in FIG. 19, and outputs the data acquisition timing shift signal det_tim_sft. The latch timing signal generation section 47 operates according to the logical table in FIG. 20, and outputs the latch timing signal LAT_TIM. In other words, the latch timing signal generation section 47 generates the latch timing signal LAT_TIM every time the timing signal en(1) is generated if det_tim_sft=1, generates the latch timing signal LAT_TIM every time the timing signal en(2) is generated if det_tim_sft=2, and generates the latch timing signal LAT_TIM every time the timing signal en(3) is generated if det_tim_sft=3. FIG. 21 is a time chart for describing the operation of the timing shift section 46.

### (F) Data Acquisition Section

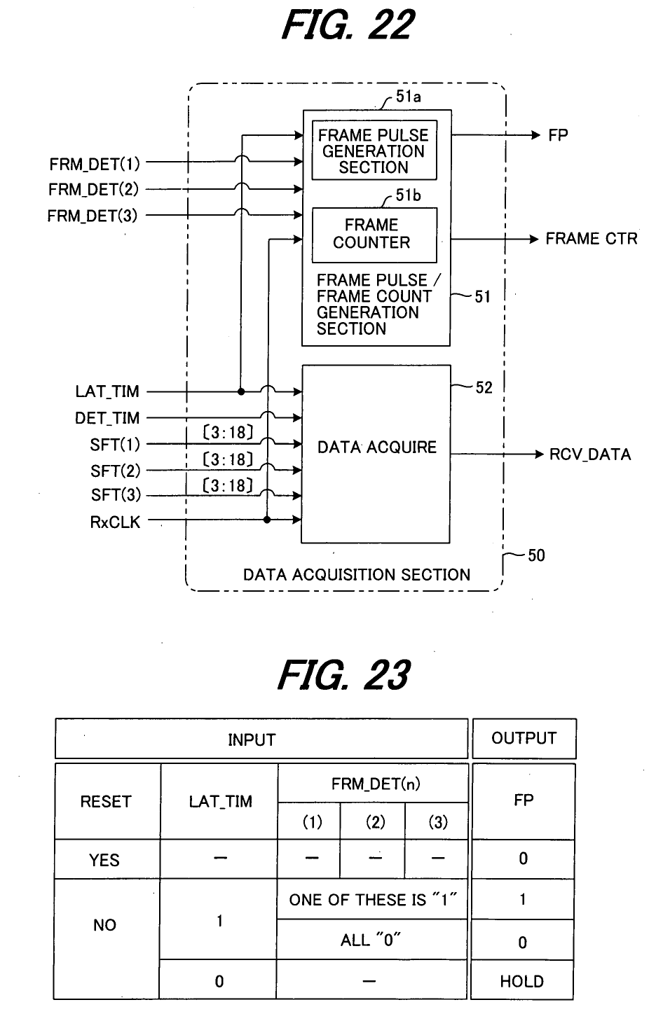

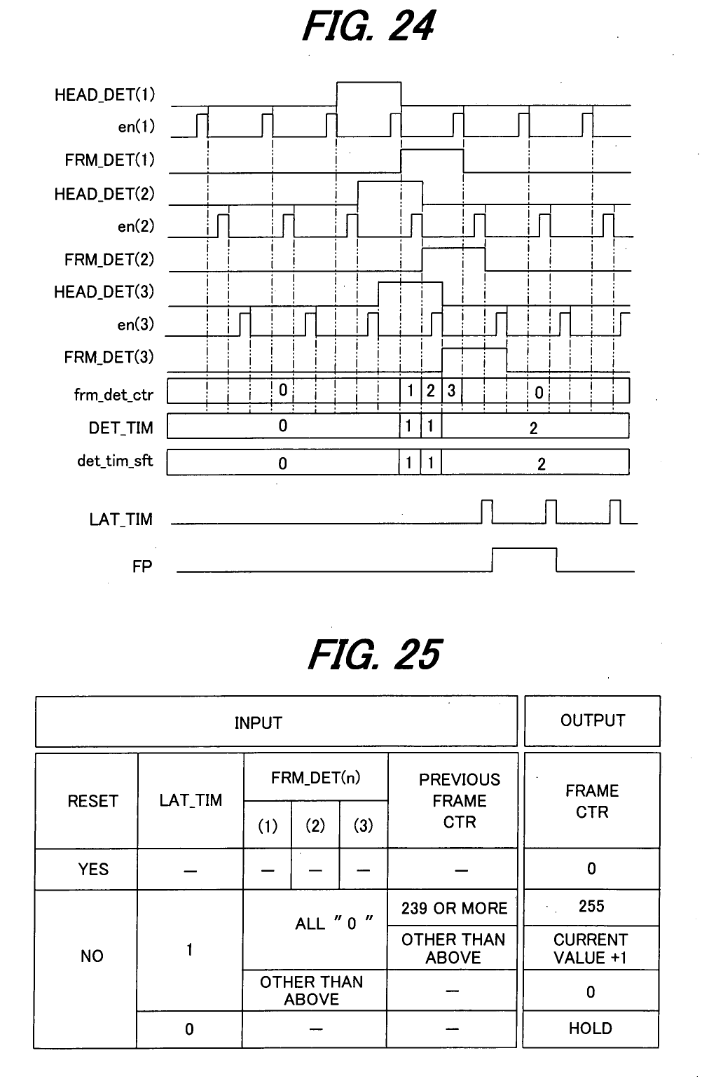

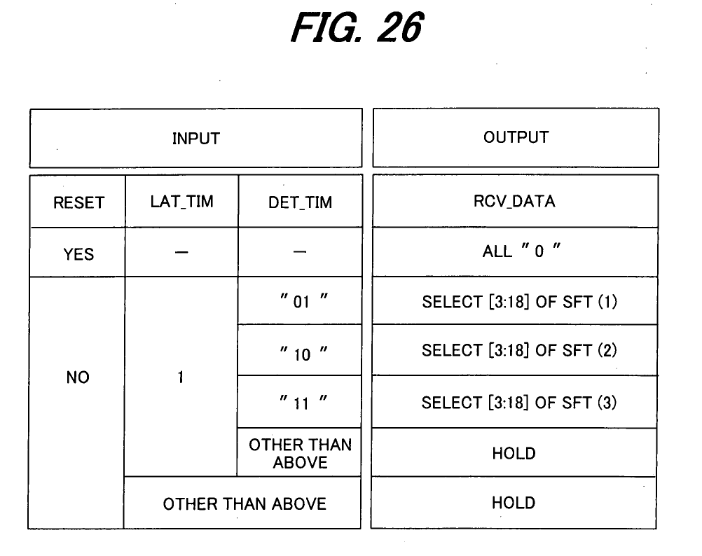

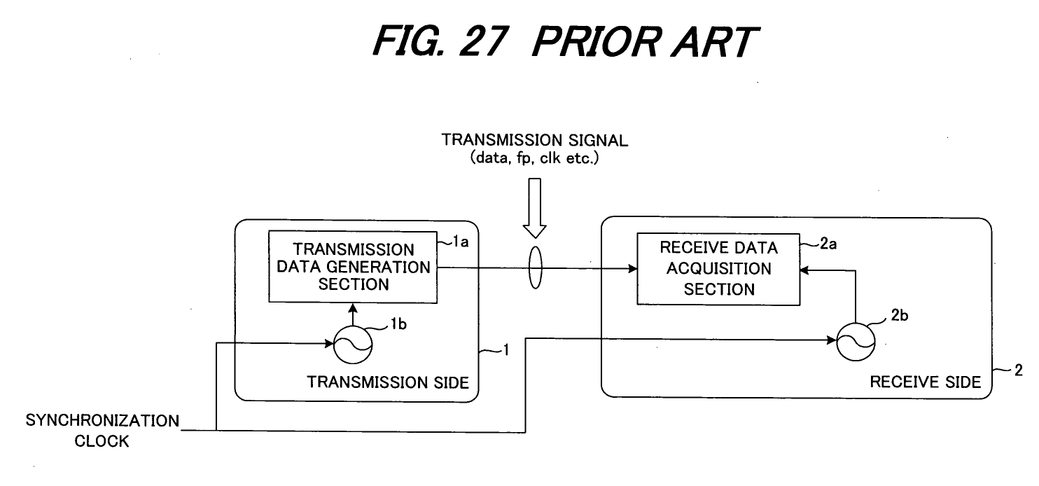

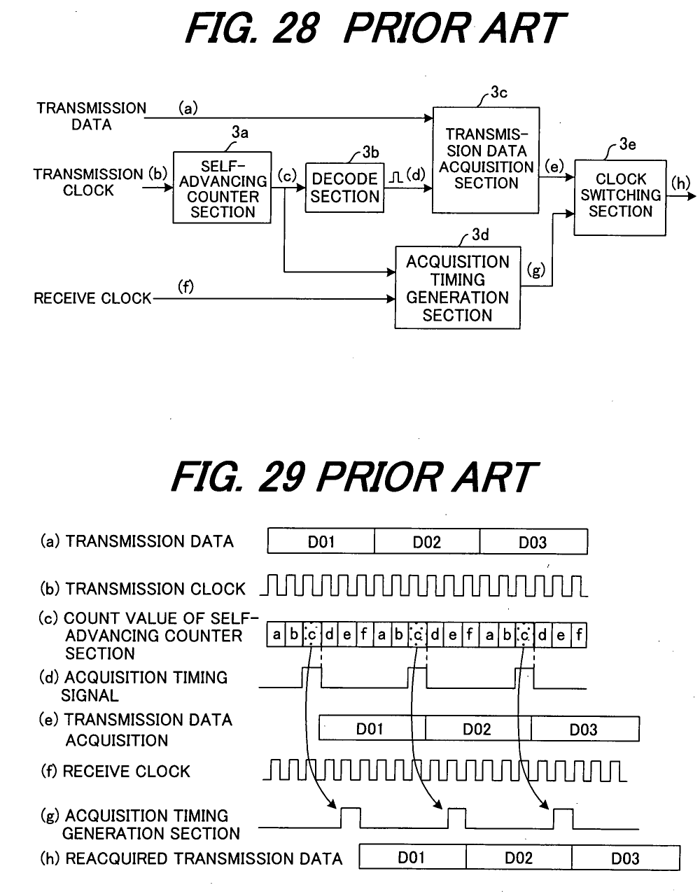

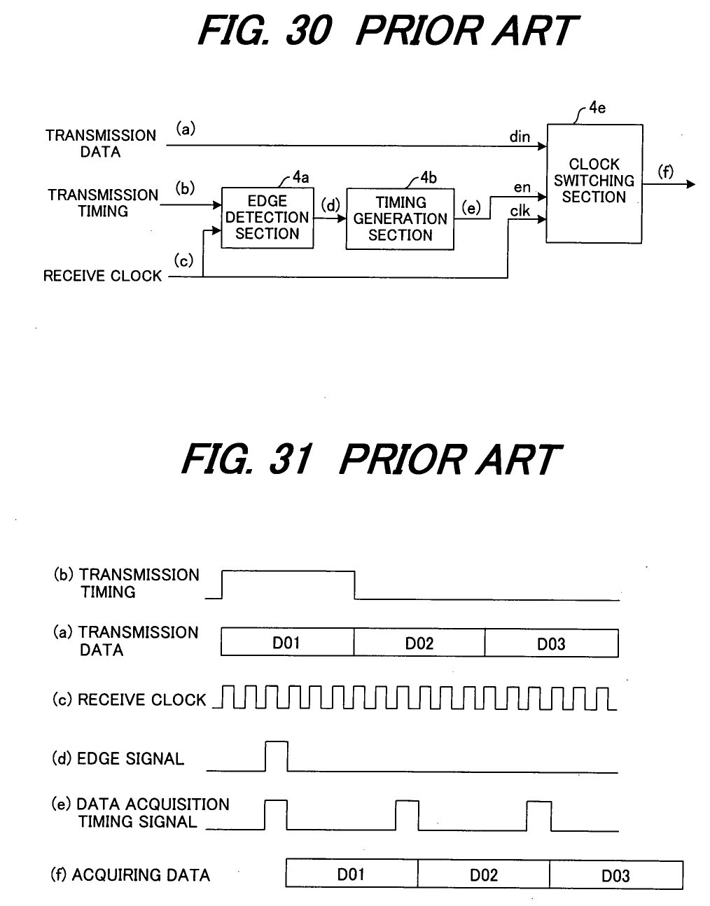

FIG. 22 is a block diagram depicting the data acquisition section 50. FIG. 23 is a logical table of the frame pulse generation section for generating the frame pulse FP which indicates the beginning of the data of the frame, FIG. 24 is a time chart for describing the frame pulse FP generation operation, FIG. 25 is a logical table of the frame counter for generating a signal which indicates the data position, and FIG. 26 is a logical table of the receive data generation.

A frame pulse/frame count generation section 51 has a frame pulse generation section 51a and a frame counter 51b, and the frame pulse generation section 51a generates a frame pulse FP according to the logical table in FIG. 23. In other words, the frame pulse generation section 51a outputs the frame pulse FP which indicates the beginning of the frame at the latch timing LAT_TIM received from the data acquisition timing decision section 40 when the frame detection signals FRM_DET(1) to FRM_DET(3) are not all 0.

The frame counter 51b performs count operation according to the logical table in FIG. 25, and outputs a signal FrameCTR which indicates the data position. In other words, the frame counter 51b acquires 0 at latch timing LAT_TIM when the frame detection signals FRM_DET(1) to FRM_DET(3) are not all 0, and increments 1 at the latch timing LAT_TIM if all are 0, and hold the value 255 if the count value is 239 or more.

A data acquisition section 52 acquires and outputs data according to the logical table in FIG. 26. In other words, in the data acquisition section 52, (1) if the data acquisition timing DET_TIM=01 (=1), the values of the 3^{rd} to 18^{th} bit data SFT (1) received from the header read monitoring section 30 are output at the timing of the latch timing signal LAT_TIM, (2) if the data acquisition timing DET_TIM=10 (=2), the values of the 3^{rd} to 18^{th} bit data SFT (2) received from the header read monitoring section 30 are output at the timing of the latch timing signal LAT_TIM, and (3) if the data acquisition timing DET_TIM=11 (=3), the values of the 3^{rd} to 18^{th} bit data SFT (3) received from the header read monitoring section 30 are output at the timing of the latch timing signal LAT_TIM.

Hereafter, the data acquisition section 52 reads the predetermined 3^{rd} to 18^{th} bit data SFT (x) from the header read monitoring section 30 in 16-bit cycles, and outputs these values in serial at the timing of the latch timing signal LAT_TIM.

### (G) Parity Check Section

The parity check section 60 (see FIG. 3) performs odd parity check operation for the receive data RCV_DATA, which is output from the data acquisition section 50 using the parity bit data PTY#1 to #8, and outputs the result thereof.

According to the present invention, it is sufficient to send only the data signals from the transmission section to the receive section, and it is unnecessary to send the clocks and the transmission timing signal which indicates the first portion of the data. Therefore the number of wirings can be decreased, and the AC characteristics for setting up/holding the clocks, need not be considered, therefore FPGA/LSI design and printed circuit board design becomes easy.

Also according to the present invention, the header of the input signal is detected and data is acquired avoiding the portion where input signal change points exist, therefore read errors can be decreased.

In the above embodiments, the case when the number of timing candidates is three was described, but the present invention can also be applied for the case when there are four or more timing candidates.

As many apparently widely different embodiments of the present invention can be made without departing from the spirit and scope thereof, it is to be understood that the invention is not limited to the specific embodiments thereof except as defined in the appended claims.

What is claimed is:

1. A data receiving device for receiving data created with a plurality of bits for each frame, and acquiring said data based on a receive side clock, comprising:
a data signal receive section for receiving a data signal which is said data created with a plurality of bits to which a header is attached at the beginning;
a clock signal generation section for generating a clock signal of which cycles are shorter than said bit cycle;
a timing candidate generation section for generating at least three clock timings within the bit cycle as candidates of a data acquisition timing;
a header read monitoring section for reading the data signal at each clock timing of said timing candidates and monitoring if the header is correctly read at each clock timing;
a timing decision section for deciding the timing candidate at the center as the data acquisition timing if there are three or more timing candidates at which the header has been correctly read; and
a data acquisition section for acquiring the receive data at said decided data acquisition timing.

2. The data receiving device according to claim 1, wherein said timing decision section further comprises:
a count section for counting the number of timing candidates at which the header has been correctly read; and
a data acquisition timing decision section where when the number of said timing candidates is three, and if there is one timing candidate at which the header has been read correctly, said timing candidate is decided as said data acquisition timing, and if there are two timing candidates at which the header has been read correctly, the timing candidate generated first is decided as said data acquisition timing, and if there are three timing candidates at which the header has been read correctly, the second timing candidate is decided as said data acquisition timing.

3. The data receiving device according to claim 1 or claim 2, wherein said header read monitoring section comprises:
a shift register which is installed for each timing candidate and is longer than the header length, for storing the result of reading a data signal at each timing candidate; and
a monitoring section for monitoring whether the header is correctly read by comparing a latest data of a header length stored in said shift register with a known header.

4. The data receiving device according to claim 3, wherein
said header read monitoring section reads data for the header length from the n-th bit of said shift register if a shift amount according to the processing time from the detection of the header to decision of data acquisition timing is n bits, and inputs the data to said data acquisition section, and
said data acquisition section acquires data for said header length at said decided data acquiring timing bit by bit.

5. The data receiving device according to claim 1, comprising a frame signal generation section for generating a frame signal which indicates the beginning of a frame at a first timing of said decided data acquisition timing.

6. A data receiving method for receiving data created with a plurality of bits for each frame, and acquiring said data based on a receive side clock, comprising the steps of:
receiving a data signal which is said data created with a plurality of bits to which a header is attached at the beginning;
generating a clock signal of which cycle is shorter than said bit cycle;
generating at least three clock timings within the bit cycle as candidates of a data acquisition timing;
reading the data signal at each clock timing of said timing candidates and monitoring if the header is correctly read at each clock timing;
deciding the timing candidate at the center as the data acquisition timing if there are three or more timing candidates at which the header has been correctly read; and
acquiring the receive data at said decided data acquisition timing.

7. The data receiving method according to claim 6, wherein in said timing deciding step, the number of timing candidates at which the header has been correctly read is counted, and when the number of said timing candidates is three, and if there is one timing candidate at which the header has been read correctly, said timing candidate is decided as said data acquisition timing, and if there are two timing candidates at which the header has been read correctly, the timing candidate generated first is decided as said data acquisition timing, and if there are three timing candidates at which the header has been read correctly, the second timing candidate is decided as said data acquisition timing.

8. The data receiving method according to claim 6 or claim 7, wherein said header reading step further comprises the steps of:
storing the result of reading a data signal at each timing candidate in a shift register which is installed for each timing candidate and is longer than the header length respectively; and
monitoring whether the header is correctly read by comparing a latest data of the header length stored in each of said shift register with a known header.

9. The data receiving method according to claim 8, wherein said data acquisition timing deciding step further comprises the steps of:
reading data for the header length from the n-th bit of said shift register if a shift amount according to processing time from detection of the header to decision of the data acquisition timing is n-bits; and
acquiring and outputting the data for said header length at said decided data acquisition timing bit by bit.

10. The data receiving method according to claim 6, wherein said data receiving method comprises a step of generating a frame signal which indicates the beginning of a frame at a first timing of said decided data acquisition timing.
